(19) United States
(12) Patent Application Publication
(10) Pub. No.: US 2019/0013025 A1
(43) Pub. Date: Jan. 10, 2019

(54) PROVIDING AN AMBIENT ASSIST MODE FOR COMPUTING DEVICES

(71) Applicant: Google Inc., Mountain View, CA (US)

(72) Inventors: Zachary Alcorn, Sunnyvale, CA (US); Alexander Friedrich Kuscher, San Francisco, CA (US); Omri Amarilio, Mountain View, CA (US); Jennifer Shien-Ming Chen, San Francisco, CA (US)

(21) Appl. No.: 15/646,011

(22) Filed: Jul. 10, 2017

(51) Int. Cl. G10L 15/28; G10L 15/22; G10L 15/30; G06F 3/16; G10L 15/32

(52) U.S. Cl. CPC G10L 15/285; G10L 15/22; G10L 2015/223; G06F 3/167; G10L 15/32; G10L 15/30

(57) ABSTRACT

The subject technology provides implementations for entering an ambient assist mode for a digital assistant. The subject technology determines, using a set of signals, to activate an ambient assist mode for a client computing device, the client computing device including a screen and a keyboard, and the client computing device is currently executing in a mode other than the ambient assist mode. Further, the subject technology activates, at the client computing device, the ambient assist mode in which the ambient assist mode enables the client computing device to enter a low power mode and listen for an audio input signal corresponding to a hotword for activating a digital assistant, and the digital assistant is configured to respond to a command corresponding to the audio input signal using at least the screen of the client computing device.

### BACKGROUND

Digital assistants can perform tasks for a user through voice activated commands. The reality of a speech-enabled home or other environment is upon us, in which a user need only speak a query or command out loud, and a computer-based system will field and answer the query and/or cause the command to be performed. A computer-based system may analyze a user's spoken words and may perform an action in response.

### SUMMARY

The disclosed subject matter relates to providing an ambient mode for a digital assistant on a given computing device.

The subject technology provides a method for entering an ambient assist mode for a digital assistant. The method determines, using a set of signals, to activate an ambient assist mode for a client computing device, the client computing device including a screen and a keyboard, the client computing device currently executing in a mode other than the ambient assist mode. The method activates, at the client computing device, the ambient assist mode, the ambient assist mode enabling the client computing device to enter a low power mode and listen for an audio input signal corresponding to a hotword for activating a digital assistant, the digital assistant configured to respond to a command corresponding to the audio input signal using at least the screen of the client computing device.

The subject technology provides a method for disambiguating a user voice command for multiple devices. The method receives a request including audio input data at a server. The method provides performing, by the server, speech recognition on the audio input data to identify, candidate terms that match the audio input data. The method determines at least one potential intended action corresponding to the candidate terms, the at least one potential intended action associated with a user command. The method determines that a plurality of client computing devices are potential candidate devices for responding to at least one potential intended action. The method identifies a particular client computing device among the plurality of client computing devices for responding to at least one potential intended action. The method provides information for display on the particular client computing device, the information corresponding to an action for responding to the user command.

The subject technology further provides a system including a processor, and a memory device containing instructions, which when executed by the processor cause the processor to: determine, using a set of signals, to activate an ambient assist mode for a client computing device, the client computing device including a screen and a keyboard, the client computing device currently executing in a mode other than the ambient assist mode; and activate, at the client computing device, the ambient assist mode, the ambient assist mode enabling the client computing device to enter a low power mode and listen for an audio input signal corresponding to a hotword for activating a digital assistant, the digital assistant configured to respond to a command corresponding to the audio input signal using at least the screen of the client computing device.

The subject technology further provides a non-transitory computer-readable medium comprising instructions, which when executed by a computing device, cause the computing device to perform operations comprising: receiving a request including audio input data at a server; performing, by the server, speech recognition on the audio input data to identify candidate terms that match the audio input data; determining at least one potential intended action corresponding to the candidate terms, the at least one potential intended action associated with a user command; determining that a plurality of client computing devices are potential candidate devices for responding to at least one potential intended action; identifying a particular client computing device among the plurality of client computing devices for responding to at least one potential intended action; and providing information for display on the particular client computing device, the information corresponding to an action for responding to the user command.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example environment including different computing devices, associated with a user, in which the subject system for providing an ambient assist mode may be implemented in accordance with one or more implementations.

FIG. 2 illustrates an example software architecture that provides an ambient assist mode for enabling a user to in accordance with one or more implementations.

FIGS. 3A-3C illustrate different example graphical displays that can be provided by a computing device while in an ambient assist mode in accordance with one or more implementations.

FIG. 4 illustrates a flow diagram of an example process for entering an ambient assist mode for a digital assistant in accordance with one or more implementations.

FIG. 5 illustrates a flow diagram of an example process for disambiguating a user voice command for multiple devices in accordance with one or more implementations.

FIG. 6 illustrates an example configuration of components of a computing device.

FIG. 7 illustrates an environment in accordance with various implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Digital assistants that respond to inputs from a user (e.g., voice or typed) are provided in existing mobile devices (e.g., smartphones) and are becoming more prevalent on larger computing devices such as laptops or desktop computers. In a given larger device that provides a digital assistant, a user can interact with the digital assistant while performing actions during an active user session with the device. However, interacting with the digital assistant may not be provided while the laptop is in a lower power state. Moreover, such a digital assistant may not provide responses to user inputs while the user is not directly in front of the laptop.

When not using a laptop, a user may place the laptop in a stationary position (e.g., on a table, etc.). Implementations of the subject technology enable such a laptop to enter into an ambient assistant mode which could also include being in a sleep or low power state. When receiving a user input (e.g., voice) while in such a low power state, the digital assistant may be activated and provide a response to the user input in a visual and/or auditory format.

Further, with the increasing popularity of computing devices, a user may own several devices that are shared across the same account. When these same devices are located in substantially the same location of the user, interacting with a digital assistant may be problematic as a voice command from a user could erroneously activate more than one device. Each of these devices may have different hardware and/or software capabilities such that for a given user command, it may be advantageous to have a particular computing device perform a task based on the user command. Existing digital assistants, however, may not provide the capability to disambiguate between a user request in this manner.

Thus, it is becoming more prevalent that a user may own several different devices for use inside their home. As an example, the user may have a mobile device such as a smartphone, and also a laptop, a streaming media device, and/or a digital assistant without a screen (e.g., a smart speaker). In a multi-device environment where a user is signed into a single account across multiple devices, a problem may arise when the user provides a user voice command and determining which device (e.g., one among many) is appropriate for handling the voice command. For example, the user 102 may be logged into computing devices 110, 120, and 130 using the same user account. In such instances, implementations of the subject technology provide techniques, at a server, for processing a received audio input data to disambiguate and select, among multiple devices, the device for handling the user voice command.

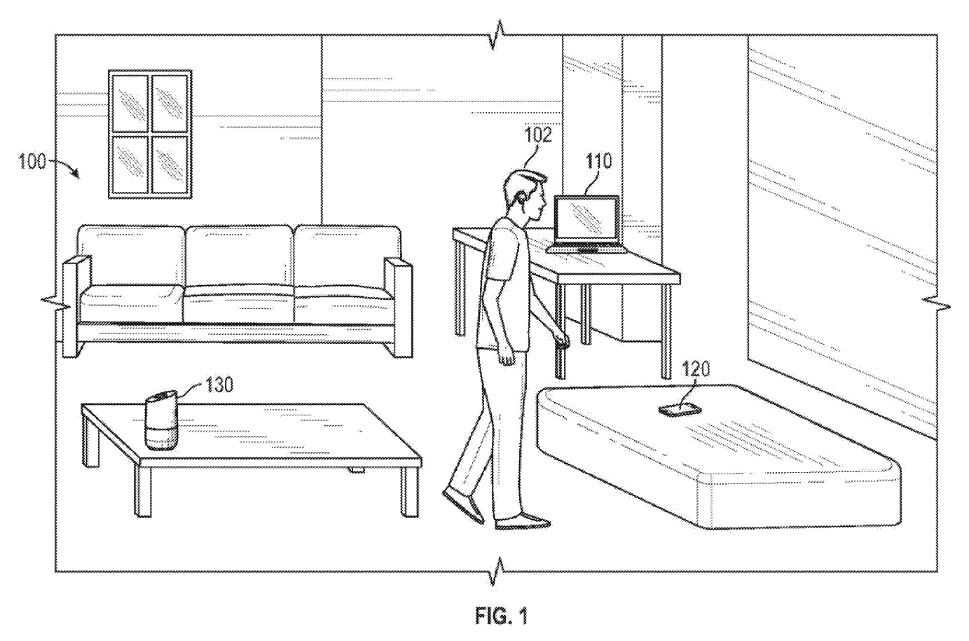

FIG. 1 illustrates an example environment 100 including different computing devices, associated with a user 102, in which the subject system for providing an ambient assist mode may be implemented in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The environment 100 includes a computing device 110, a computing device 120, and a computing device 130 at different locations within the environment 100. The computing devices 110, 120, and 130 may be communicatively (directly or indirectly) coupled with a network that provides access to a server and/or a group of servers (e.g., multiple servers such as in a cloud computing or data center implementation). In one or more implementations, the network may be an interconnected network of devices that may include, or may be communicatively coupled to, the Internet.

The computing device 110 may include a touchscreen and may be, for example, a portable computing device such as a laptop computer that includes a touchscreen, a smartphone that includes a touchscreen, a peripheral device that includes a touchscreen (e.g., a digital camera, headphones), a tablet device that includes a touchscreen, a wearable device that includes a touchscreen such as a watch, a band, and the like, any other appropriate device that includes, for example, a touchscreen, or any computing device with a touchpad. In one or more implementations, the computing device 110 may include a touchpad. The computing device 110 may be configured to receive handwritten input via different input methods including touch input, or from an electronic stylus or pen/pencil.

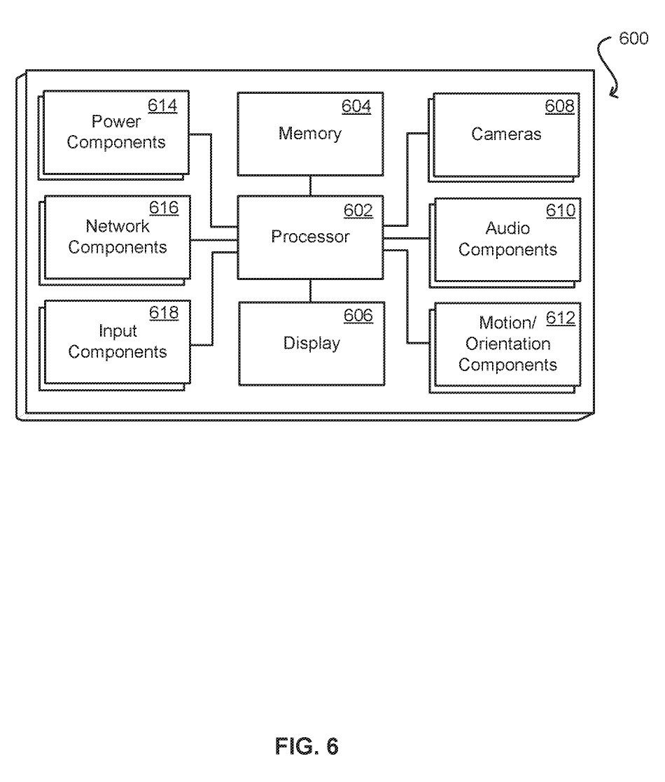

In FIG. 1, by way of example, the computing device 110 is depicted as a laptop device with a keyboard and a touchscreen (or any other type of display screen), and includes at least one speaker and at least one microphone (or other component(s) capable of receiving audio input from the voice of the user 102) to enable interactions with the user 102 via voice commands that are uttered by the user 102. A microphone as described herein may be any acoustic-to-electric transducer or sensor that converts sound into an electrical signal (e.g., using electromagnetic induction, capacitance change, piezoelectric generation, or light modulation, among other techniques, to produce an electrical voltage signal from mechanical vibration, etc). In another example, the computing device may include an array of (same or different) microphones. In one or more implementations, the computing device 110 may be, and/or may include all or part of, the computing device discussed below with respect to FIG. 6.

When not using the computing device 110, the user 102 may place the computing device 110 in a stationary position (e.g., on a table, etc.). The computing device 110 may enter into an ambient assistant mode which could also include being in a sleep or low power state (e.g., where at least some functionality of the computing device 110 is disabled). When the computing device 110 receives a user input (e.g., voice), a digital assistant may be activated and provide a response to the user input in a visual (e.g., in a full-screen mode using the screen of the computing device 110) and/or auditory format (e.g., using one or more speakers of the computing device 110). In this manner, the digital assistant on the computing device 110 may provide information that is glanceable (e.g., viewed by the user 102 in a quick and/or easy manner) and/or audible by the user 102 from various positions within the environment 100 and/or while the user 102 is moving within the environment 100.

The computing device 110 may include a low power recognition chip which enables the device to recognize voice input while in a low power or sleep mode. In an example, the low power recognition chip may consume between 0 and 10 milliwatts of power, depending on a number of words that is included in the user voice input. The computing device 110 may remain in a low power mode before detecting audio corresponding to a hotword or phrase (e.g., “OK Assistant” or “Hey Assistant”) that launches the digital assistant into the ambient assist mode. As referred to herein, a “hotword” may refer to a term or phrase that wakes up a device from a low power state (e.g., sleep state or hibernation state), or a term or phrase that triggers semantic interpretation on the term and/or on one or more terms that follow the term (e.g., on a voice command that follows the hotword). Further, the computing devices 120 and/or 130 may also include such a low power recognition chip for enabling recognition of voice input from the user 102.

The example of FIG. 1 further includes the computing device 120, which may be, for example, desktop computer, a portable computing device such as a laptop computer, a smartphone, a peripheral device (e.g., a digital camera, headphones), a tablet device, a wearable device such as a watch, a band, and the like, or any other appropriate device that includes, for example, one or more wireless interfaces, such as WLAN radios, cellular radios, Bluetooth radios, Zigbee radios, Z-Wave radios, near field communication (NFC) radios, and/or other wireless radios.

In FIG. 1, by way of example, the computing device 120 is depicted as a mobile computing device (e.g., smartphone) with a touch-sensitive screen, which includes at least one speaker and at least one microphone (or other component(s) capable of receiving audio input from the voice of the user 102) to also enable interactions with the user 102 via voice commands that are uttered by the user 102. The computing device 120 may be, and/or may include all or part of, the computing device discussed below with respect to FIG. 6.

FIG. 1 also includes the computing device 130, which is depicted as a computing device (e.g., a speech-enabled or voice-controlled device) without a display screen. The computing device 130 may include at least one speaker and at least one microphone (or other component(s) capable of receiving audio input from the voice of the user 102) to enable interactions with the user 102 in an auditory manner. The computing device 130 may be, and/or may include all or part of, the computing device discussed below with respect to FIG. 6.

Although three separate computing devices are illustrated in the example of FIG. 1, it is appreciated that more or fewer devices may be provided as part of the subject system that implements an ambient assist mode.

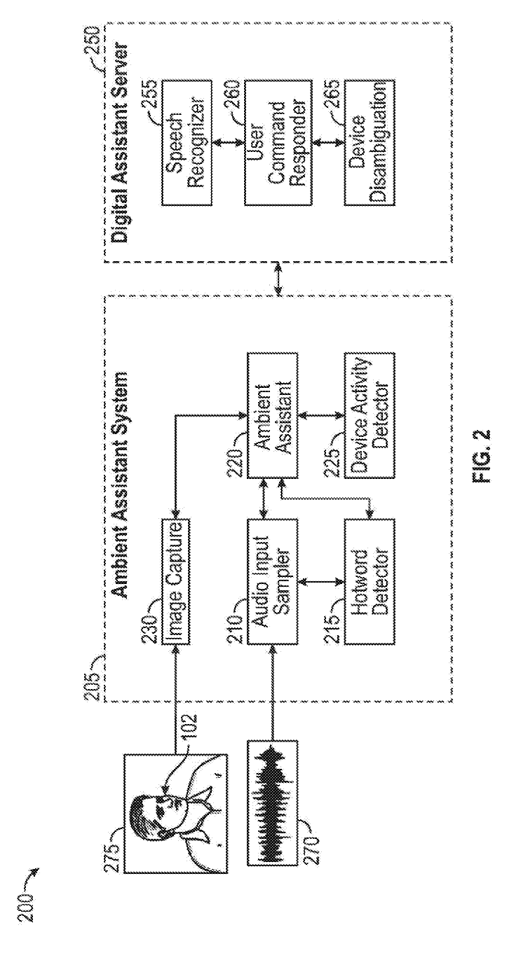

FIG. 2 illustrates an example software architecture 200 that provides an ambient assist mode for enabling a user to in accordance with one or more implementations. For explanatory purposes, portions of the software architecture 200 are described as being provided by the computing device 110 of FIG. 1, such as by a processor and/or memory of the computing device 110; however, the software architecture 200 may be implemented by any other computing device. The software architecture 200 may be implemented in a single device or distributed across multiple devices. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The computing device 110 may include an ambient assist system 205 that includes an audio input sampler 210, a hotword detector 215, an ambient assist component 220, a device activity detector 225, and an image capture component 230.

In an example, when not using the computing device 110, the user 102 may place the computing device 110 in a stationary position (e.g., on a table, etc.). Based on one or more signals (described further herein), the computing device 110 may enter into an ambient assistant mode which could also include being in a sleep or low power state. When receiving a user input (e.g., voice), a digital assistant provided by the ambient assist component 220 may be activated and provide a response to the user input in a visual and/or auditory format.

In one or more implementations, the ambient assist component 220 may use one or more of the following signals to determine whether to enter in the ambient assistant mode:
Recency of a user action (e.g., a last time that the user 102 interacted with the computing device 110) provided by e device activity detector 225. In an example, if the last user action was within a threshold time period (e.g., 10 minutes), the computing device 110 may delay entering into the ambient assist mode. Alternatively, if at least a threshold time period has elapsed since the last user action, the computing device 110 may enter into the ambient assist mode.
Accelerometer data (e.g., a last time that the device was moved) provided by the device activity detector 225. In an example, if the accelerometer data indicates that the computing device 110 is currently moving, or was last moved within a threshold time period (e.g., 5 minutes), the computing device 110 may forgo entering into the ambient assist mode.
Input image data captured by the image capture component 230 used for determining who is in the room (e.g., from facial recognition which can utilize machine learning techniques), and/or how far the user 102 is from the computing device 110. In an example, if a captured image indicates that the user 102 is not within the same room, the computing device 110 may forgo entering into the ambient assist mode. In another example, if facial recognition fails to identify the user 102, the computing device 110 may also forgo entering into the ambient assist mode.
Audio input captured by the audio input sampler 210 based on using voice recognition to identify and/or location of a speaker, or determine loudness of the voice.
Time of day and user behavior over time (e.g., the user interacts with the computing device 110 in the ambient assist mode at particular time(s) during the day versus other times) provided by the device activity detector 225.
Location (e.g., if the user 102 is at home, then the computing device 110 may be in the ambient assist mode more frequently versus when the user 102 is outside the home); location may be determined using a variety signals: geolocation coordinates, name of a Wi-Fi network currently connected to, which other devices are in proximity, etc.; location may also be determined using machine learning techniques to predict the user's 102 location.

In one or more implementations, the device activity detector 225 can detect activity on the computing device 110 including at least recent user actions and also receive information from different sensors (e.g., accelerometer data) on the computing device 110 and then provide this information in the form of signals that are sent to the ambient assist component 220. The ambient assist component 220 may also receive input from the image capture component 230 and/or the audio input sampler 210. In one or more implementations, the image capture component 230 includes one or more cameras or image sensors for capturing image or video content. The ambient assist component 220 may utilize machine learning techniques to perform facial recognition on a captured image received from the image capture component 230, such as an image 275 of the user 102. For example, the ambient assistant component 220 may utilize a machine learning model to perform facial recognition on the image 275 and detect the user 102. In one implementation, facial recognition identifies the location of a face of a person in an image, and then seeks to use a signature of the person's face to identify that person by name or by association with other images that contain that person.

In one or more implementations, the audio input sampler 210 processes audio input 270 captured by at least one microphone provided by the computing device 110. For a speech-enabled system such as the ambient assist system 205 as described herein, the manner of interacting with the system is designed to be primarily, in an example, by means of voice input provided by the user 102. The ambient assist system 205, which potentially picks up all utterances made in the surrounding environment including those not directed to the system, may have some way of discerning when any given utterance is directed at the system. One way to accomplish this is to use a hotword, which is reserved as a predetermined word that is spoken to invoke the attention of the system.

In one example environment, the hotword used to invoke the system's attention are the words “OK assistant.” Consequently, each time the words “OK assistant” are spoken, it is picked up by a microphone provided by the computing device 110, and conveyed to the ambient assist system 205, which utilizes speech recognition techniques to determine whether the hotword was spoken and, if so, awaits an ensuing command or query. Accordingly, utterances directed at the ambient assist system 205 can take the general form [HOTWORD] [QUERY], where “HOTWORD” in this example is “OK assistant” and “QUERY” can be any question, command, declaration, or other request that can be speech recognized, parsed and acted on by the ambient assist system 205, either alone or in conjunction with a server (e.g., a digital assistant server 250) via a network.

The ambient assist system 205 may receive vocal utterances or sounds from the captured audio input 270 that includes spoken words from the user 102. In an example, the audio input sampler 210 may capture audio input corresponding to an utterance, spoken by the user 102, that is sent to the hotword detector 215. The utterance may include a hotword, which may be a spoken phrase that causes the ambient assist system 205 to treat a subsequently spoken phrase as a voice input for the ambient assist system 205. Thus, a hotword may be a spoken phrase that explicitly indicates that a spoken input is to be treated as a voice command, which may then initiate operations for isolating where individual words or phrases begin and end within the captured audio input, and/or performing speech recognition including semantic interpretation on the hotword or one or more terms that follow the hotword.

The hotword detector 215 may receive the captured audio input 270 including the utterance and determine if the utterance includes a term that has been designated as a hotword (e.g., based on detecting that some or all of the acoustic features of the sound corresponding to the hotword are similar to acoustic features characteristic of a hotword.). Subsequent words or phrases not corresponding to the hotword may be designated as a voice command that is preceded by the hotword. Such a voice command may correspond to a request from the user 102.

If the hotword detector 215 determines that the utterance may include a hotword, the ambient assist component 220 may send the captured audio input to a digital assistant server 250 to recognize speech in the captured audio input. As illustrated, the digital assistant server 250 includes a speech recognizer 255, a user command responder 260, and a device disambiguation component 265. Although for purposes of explanation the digital assistant server 250 is shown as being separate from the ambient assist system 205, in at least one implementation, the ambient assist system 205 may perform some or all of the functionality described in connection with the digital assistant server 250. In one or more implementations, the digital assistant server 250 may provide an application programming interface (e.g., API) such that the ambient assistant system 205 may invoke remote procedure calls in order to submit requests to the digital assistant server 250 for performing different operations, including at least, responding to a given user voice command. In one or more implementations, the digital assistant server 250 may be, and/or may include all or part of, the computing device discussed below with respect to FIG. 6.

In one or more implementations, the speech recognizer 255 may perform speech recognition to interpret the user's 102 request or command. Such requests may be for any type of operation, such as search requests, different types of inquiries, requesting and consuming various forms of digital entertainment and/or content (e.g., finding and playing music, movies or other content, personal photos, general photos, etc.), weather, scheduling and personal productivity tasks (e.g., calendar appointments, personal notes or lists, etc.), shopping, financial-related requests, etc.

In one or more implementations, the speech recognizer 255 may transcribe the captured audio input 270 into text. For example, the speech recognizer 255 may transcribe the captured sound corresponding to the utterance “OK ASSISTANT, WHAT'S THE WEATHER LIKE TODAY” into the text “Ok Assistant. What's The Weather Like Today.” In some implementations, the speech recognizer 255 may not transcribe the portion of the captured audio input that corresponds to the hotword (e.g., “OK, ASSISTANT”). For example, for the utterance “OK ASSISTANT, WHAT'S THE WEATHER LIKE TODAY,” the speech recognizer 255 may omit transcribing the portion of the captured sound corresponding to the hotword “OK ASSISTANT” and only transcribe the following portion of the captured sound corresponding to “WHAT'S THE WEATHER LIKE TODAY.”

In one or more implementations, the speech recognizer 255 may utilize endpointing techniques to isolate where individual words or phrases begin and end within the captured audio input 270. The speech recognizer 255 may then transcribe the isolated individual words or phrases into text.

Using the transcribed text, the user command responder 260 may then determine how to respond to the request included in the voice command provided by the user 102. In an example where the request corresponds to a request for particular information (e.g., the daily weather), the user command responder 260 may obtain this information locally or remotely (e.g., from a weather service) and subsequently send this information to the requesting computing device.

In a multi-device environment where the user 102 is signed into a single account across multiple devices, a problem may arise when the user 102 provides a user voice command and determining which device (e.g., one among many) is appropriate for handling the voice command. For example, the user 102 is logged into computing devices 110, 120, and 130 using the same user account associated with the user 102. In such instances, implementations of the subject technology provide techniques, at a server (e.g., the digital assistant server 250), for processing a received audio input data to disambiguate, among multiple devices, the particular device for handling the user voice command. As used herein, the term “disambiguate” may refer to techniques for selecting a particular computing device, based on one or more heuristics and/or signals, among multiple devices for responding to a given user voice command. Such devices, as described before, may be associated with the same user account.

In an example, the digital assistant server 250 may therefore have access to user profile information that provides information regarding which computing devices are associated with the user 102 based on which devices that the user 102 is currently logged into at the current time. The digital assistant server 250 may store device identifiers for such computing devices that are associated with the user 102. In one or more implementations, the identifiers may be based on a type of device, an IP address of the device, a MAC address, a name given to the device by the user 102, or any similar unique identifier. For example, the device identifier for the computing device 110 may be “laptop,” the device identifier for the computing device 120 may be “phone,” and the device identifier for computing device 130 may be “smart speaker.” The device identifiers may then be utilized by one or more components of the digital assistant server 250 for identifying a particular computing device.

As further illustrated, the digital assistant server 250 includes the device disambiguation component 265. In an example where the user 102 provides a user voice command at a particular position in the environment 100, it may be understood that each of the computing devices 110, 120, and 130 may capture the user voice command as respective audio input and then send the respective audio input over to the digital assistant server 250. For example, when the user 102 speaks a given voice command including a hotword to activate a digital assistant, each of the computing devices 110, 120, and 130 that has an audio input device (e.g., such as a microphone) in the vicinity of the user 102 can capture and process the user voice command, and subsequently send the user voice command to the digital assistant server 250 for further processing to respond to the user voice command.

For selecting a particular computing device associated with the user 102 for responding to a given user voice command, in an example, the device disambiguation component 265 may determine and utilize one or more of the following to disambiguate the user voice command:
1. Which computing device “heard” the user 102 the best (e.g., based on volume, loudness, and/or some other audio metric from the captured audio input)? For multiple computing devices, the device disambiguation component 265 may select a particular computing device associated with the loudest captured audio input.
2. Determine a confidence score that the request provided in the captured audio input was transcribed correctly by the speech recognizer 255 based on detected audio features in the captured audio input. The speech recognizer 255 compares the captured audio input to known audio data and computes a confidence score that indicates the likelihood that the captured audio input corresponds to one or more words or terms. The confidence score, in an example, is typically a numerical value that is between zero and one, and the closer the confidence score is to one, the greater the likelihood that the captured audio input was transcribed correctly. For multiple computing devices, the device disambiguation component 265 may select a particular computing device corresponding to the highest confidence score. In another example, the device disambiguation component 265 may disregard any computing device that has an associated confidence score below a confidence score threshold.
3. Which device is closest to the user 102 (e.g., using beamforming to triangulate position)? In an example, the device disambiguation component 265 may select a particular computing device that is closest to the user 102.
4. Which device is “best” suited to perform a task associated with the user voice command?

With respect to (4) above, the device disambiguation component 265 can determine the current hardware and/or software capabilities of a particular computing device (e.g., one or more of the computing devices 110, 120 and/or 130) to select the device that may be best suited for handling the user voice command. For example, if the user voice commands corresponds to a request for sending a SMS text message, the device disambiguation component 265 can select the user's smartphone (e.g., the computing device 120) to handle this request. In another example, a user voice command may correspond to a task for playing a video. In this example, the device disambiguation component 265 may select a particular device with the largest screen among the user's multiple devices (e.g., the computing device 110).

Based on the selected computing device provided by the device disambiguation component 265, the user command responder 260 may then send information corresponding to a response to the request included in the voice command provided by the user 102. For example, if the device disambiguation component 265 selects the computing device 110 to respond to a request for playing some form of media content (e.g., video, music, etc.), the user command responder 260 may then send information (e.g., a URL or link to the media content, or the requested media content itself in a streamed format) to the computing device 110 for playing such content. In another example, if the device disambiguation component 265 selects the computing device 120 to respond to a request for sending an SMS message, the user command responder 260 may then send information (e.g., contact information of the intended recipient of the SMS message) to the computing device 120 for sending the SMS message.

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

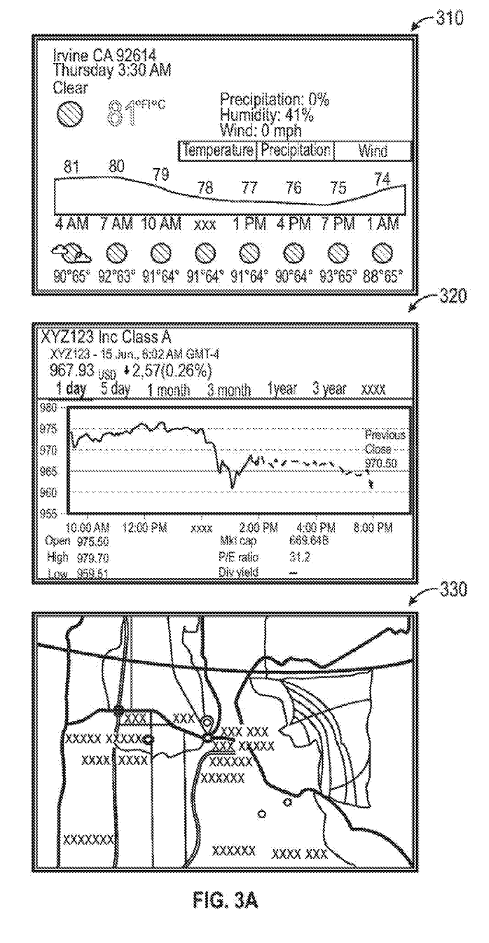

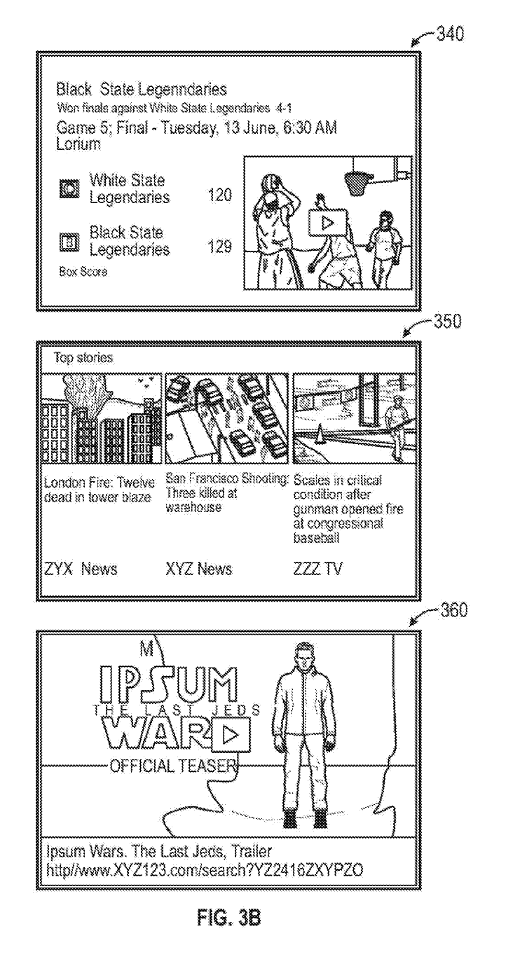

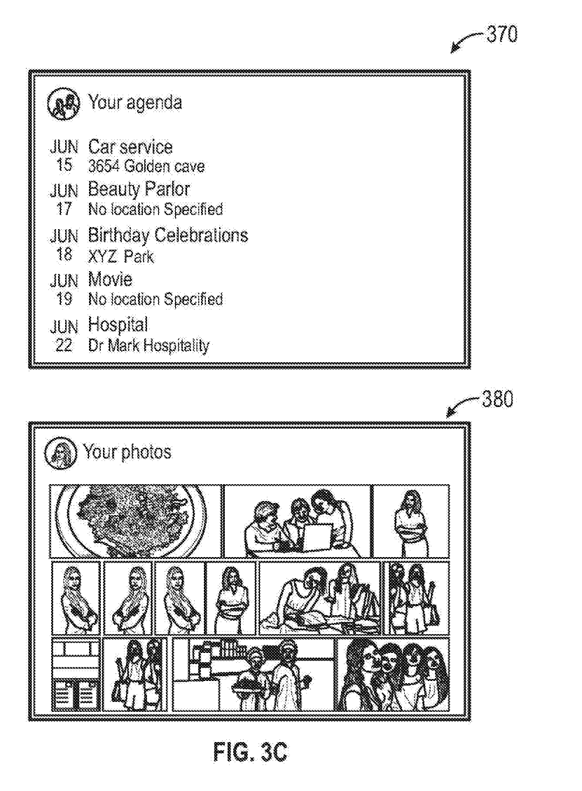

FIGS. 3A-3C illustrate different example graphical displays that can be provided by a computing device while in an ambient assist mode in accordance with one or more implementations. For example, the computing device 110 may display such graphical displays as a full-screen display in response to different user voice commands that are processed by the ambient assistant system 205 and/or the digital assistant server 250.

Graphical display 310 of FIG. 3A is an example display in response to a user voice command for the daily weather (e.g., “OK ASSISTANT, WHAT'S THE WEATHER LIKE TODAY”). As illustrated, the graphical display 310 includes temperatures throughout different hours of a given day.

Graphical display 320 of FIG. 3A is an example display in response to a user voice command for the current stock price of a given company on a given date (e.g., “OK ASSISTANT, SHOW ME THE LATEST STOCK PRICE FOR XYZ123 COMPANY”). The graphical display 320 includes a graph of the price of the stock throughout the day (e.g., from the opening of the stock market to the close and into after-market trading hours).

Graphical display 330 of FIG. 3A is an example display in response to a user voice command for a map of a given geographical location (e.g., “OK ASSISTANT, SHOW ME A MAP OF MOUNTAIN VIEW”). The graphical display 330 includes a flat overhead view of the requested geographical location.

Graphical display 340 of FIG. 3B is an example display in response to a user voice command for the latest score of a sports team (e.g., “OK ASSISTANT, WHAT'S THE SCORE OF THE BLACK STATE LEGENNDARIES GAME”). The graphical display 340 includes the score of the most recent game of the sports team, and a video segment showing highlights of the game.

Graphical display 350 of FIG. 31B is an example display in response to a user voice command for the latest news (e.g., “OK ASSISTANT, WHAT'S THE LATEST NEWS HEADLINES”). The graphical display 350 includes three different top news stories from different news sources.

Graphical display 360 of FIG. 3B is an example display in response to a user voice command for a movie trailer of a given movie (e.g., “OK ASSISTANT, SHOW ME THE TRAILER FOR IPSUM WAR”). The graphical display 360 includes a video segment of the movie trailer that may be played by the computing device 110.

Graphical display 370 of FIG. 3C is an example display in response to a user voice command for scheduled meetings during a given period of time (e.g., “OK ASSISTANT, WHAT MEETINGS DO I HAVE FOR THIS WEEK”). The graphical display 370 includes a listing of different meetings or scheduled appointments for the period of time.

Graphical display 380 of FIG. 3C is an example display in response to a user voice command for photos (e.g., “OK ASSISTANT, SHOW ME MY MOST RECENT PHOTOS”). The graphical display 380 includes a gallery of the most recent photos for the user.

It is appreciated that other types of graphical displays may be provided in addition to those illustrated in FIGS. 3A-3C.

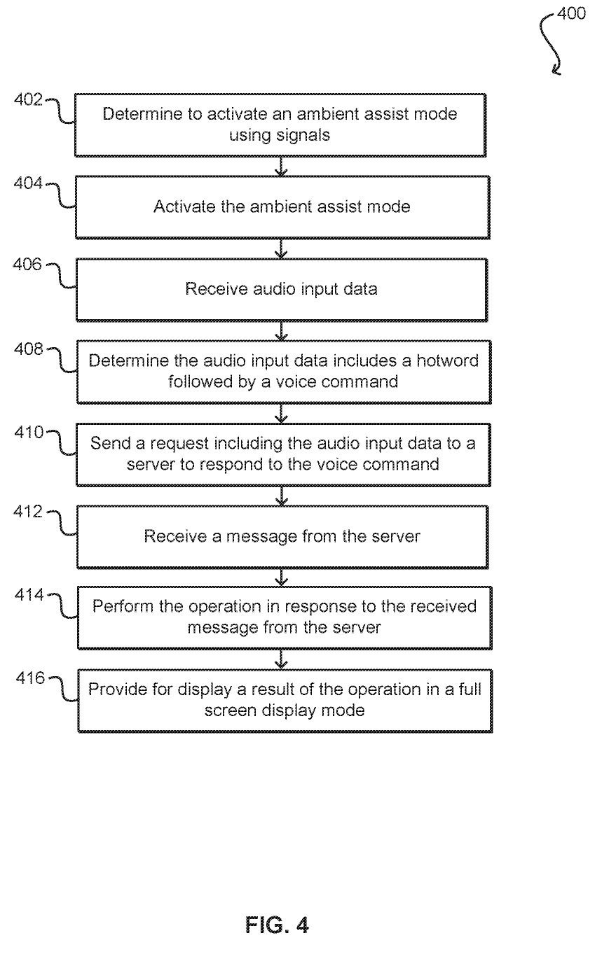

FIG. 4 illustrates a flow diagram of an example process for entering an ambient assist mode for a digital assistant in accordance with one or more implementations. For explanatory purposes, the process 400 is primarily described herein with reference to the computing device 110 of FIG. 1. However, the process 400 is not limited to the computing device HO, and one or more blocks (or operations) of the process 400 may be performed by one or more other components of other suitable devices and/or software applications. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

The computing device 110 determines, using a set of signals, to activate an ambient assist mode for a client computing device that includes a screen and a keyboard (e.g., the computing device 110) (402). The signals may include those discussed above by reference to FIG. 2. In an implementation, the client computing device is currently executing in a mode other than the ambient assist mode. This mode may correspond to a higher power mode in which the client computing device utilizes more power (e.g., than what the client computing device utilizes when in the ambient assist mode) and is executing one or more applications.

Based on the set of signals, the computing device 110 (404) activates, at the client computing device (e.g., the computing device 110), the ambient assist mode. In an example, the ambient assist mode enables the client computing device (e.g., the computing device 110) to enter a low power mode and listen for an audio input signal corresponding to a hotword for activating a digital assistant. The digital assistant is configured to respond to a command corresponding to the audio input signal by using at least the screen of the client computing device. While in the ambient assist mode, the client computing device may stop executing any (or all) application(s) that the client computing device was executing prior to activating the ambient assist mode.

The computing device 110 receives audio input data (406). The computing device 110 determines that the audio input data includes a hotword followed by a voice command (408). The computing device 110 sends a request including the audio input data to a server (e.g., the digital assistant server 250) to respond to the voice command (410).

The computing device 110 receives a message from the server, the message including information corresponding to an operation to be performed by the client computing device for responding to the voice command (412).

The computing device 110 performs the operation in response to the received message from the server (414). The computing device 110 provides for display a result of the operation in a full screen display mode of a screen of the client computing device, the result including information associated with the operation (416).

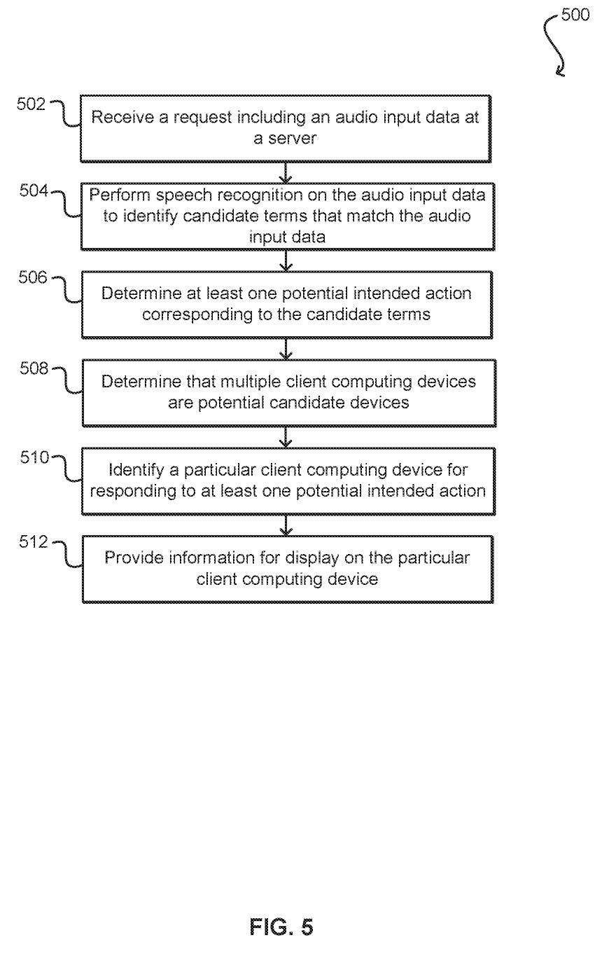

FIG. 5 illustrates a flow diagram of an example process 500 for disambiguating a user voice command for multiple devices in accordance with one or more implementations. For explanatory purposes, the process 500 is primarily described herein with reference to components of the digital assistant server 250 of FIG. 2. However, the process 500 is not limited to the digital assistant server 250, and one or more blocks (or operations) of the process 500 may be performed by one or more other components of other suitable devices and/or software applications. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

The digital assistant server 250 receives a request including audio input data at a server (502). In an example, the request is associated with a user account of the user 102. The digital assistant server 250 performs speech recognition on the audio input data to identify candidate terms that match the audio input data (504). The digital assistant server 250 determines at least one potential intended action corresponding to the candidate terms, the at least one potential intended action associated with a user command (506). The digital assistant server 250 determines that multiple client computing devices are potential candidate devices for responding to at least one potential intended action (508).

The digital assistant server 250 identifies a particular client computing device among the multiple of client computing devices for responding to at least one potential intended action (510). In an example, identifying the particular client computing device among the multiple client computing devices is based on at least one of a volume of the received audio input data, a confidence score associated with the at least one potential intended action associated with the user command, a location of a client computing device, and hardware or software capabilities of a client computing device.

The digital assistant server 250 provides information for display on the particular client computing device, the information corresponding to an action for responding to the user command (512). In an example, providing information for display on the particular client computing device, the information corresponding to an action for responding to the user command further includes sending a message to the particular client computing device, the message including the information corresponding to the action for responding to the user command.

FIG. 6 illustrates a logical arrangement of a set of general components of an example computing device 600. In this example, the device includes a processor 602 for executing instructions that can be stored in a memory component 604. The memory component can include many types of memory, data storage, or non-transitory computer-readable storage media, such as a first data storage for program instructions for execution by the processor 602, a separate storage for images or data, a removable memory for sharing information with other devices, etc. The device typically may include some type of display element 606, such as a touchscreen, electronic ink (e-ink), organic light emitting diode (OLED), liquid crystal display (LCD), etc., although devices such as portable media players might convey information via other means, such as through audio speakers. In at least some implementations, the display screen provides for touch or swipe-based input using, for example, capacitive or resistive touch technology. The device in many implementations may include one or more cameras or image sensors 608 for capturing image or video content. A camera can include, or be based at least in part upon any appropriate technology, such as a CCD or CMOS image sensor having a sufficient resolution, focal range, viewable area, to capture an image of the user when the user is operating the device. An image sensor can include a camera or infrared sensor that is able to image projected images or other objects in the vicinity of the device. It should be understood that image capture can be performed using a single image, multiple images, periodic imaging, continuous image capturing, image streaming, etc.

Further, a device can include the ability to start and/or stop image capture, such as when receiving a command from a user, application, or other device. The example device can include at least one audio component 610, such as a mono or stereo microphone or microphone array, operable to capture audio information from at least one primary direction. A microphone can be a uni- or omni-directional microphone as known for such devices.

The computing device 600 also can include at least one orientation or motion sensor 612. As discussed, such a sensor can include an accelerometer or gyroscope operable to detect an orientation and/or change in orientation, or an electronic or digital compass, which can indicate a direction in which the device is determined to be facing. The mechanism(s) also (or alternatively) can include or comprise a global positioning system (GPS) or similar positioning element operable to determine relative coordinates for a position of the computing device, as well as information about relatively large movements of the device. The computing device 600 can include other elements as well, such as may enable location determinations through triangulation or another such approach. These mechanisms can communicate with the processor 602, whereby the computing device 600 can perform any of a number of actions described or suggested herein.

The computing device 600 also includes various power components 614 for providing power to a computing device, which can include capacitive charging elements for use with a power pad or similar device. The computing device 600 can include one or more communication elements or networking sub-systems 616, such as a Wi-Fi, Bluetooth, RF, wired, or wireless communication system. The computing device 600 in many implementations can communicate with a network, such as the Internet, and may be able to communicate with other such devices. In some implementations the computing device 600 can include at least one additional input element 618 able to receive conventional input from a user. This conventional input can include, for example, a push button, touch pad, touchscreen, wheel, joystick, keyboard, mouse, keypad, or any other such component or element whereby a user can input a command to the computing device 600. In some implementations, however, such a device might not include any buttons at all, and might be controlled only through a combination of visual and audio commands, such that a user can control the device without having to be in contact with the device.

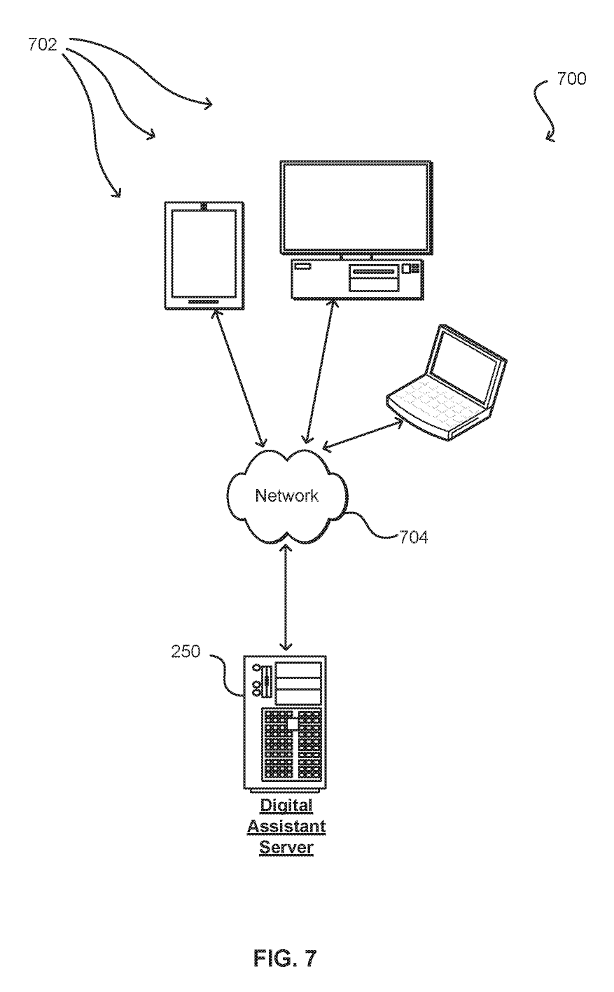

As discussed, different approaches can be implemented in various environments in accordance with the described implementations. For example, FIG. 7 illustrates an example of an environment 700 for implementing aspects in accordance with various implementations. As can be appreciated, although a Web-based environment is used for purposes of explanation, different environments may be used, as appropriate, to implement various implementations. The system includes electronic client devices 702, which can include any appropriate device operable to send and receive requests, messages or information over an appropriate network 704 and convey information back to a user of the device. Examples of such client devices include personal computers, cell phones, handheld messaging devices, laptop computers, set-top boxes, personal data assistants, electronic book readers and the like. In an example, the electronic client devices 702 may include the computing devices 110, 120, and 130 as described by reference to FIG. 1 above.

The network 704 can include any appropriate network, including an intranet, the Internet, a cellular network, a local area network or any other such network or combination thereof. Components used for such a system can depend at least in part upon the type of network and/or environment selected. Communication over the network 704 can be enabled via wired or wireless connections and combinations thereof. In this example, the network 704 includes the Internet, as the environment includes the digital assistant server 250 by reference to FIG. 2 for receiving requests and serving content and/or information in response thereto, although for other networks, an alternative device serving a similar purpose could be used.

The digital assistant server 250 typically can include an operating system that provides executable program instructions for the general administration and operation of that server and typically can include computer-readable medium storing instructions that, when executed by a processor of the server, allow the server to perform its intended functions. The environment in one implementation is a distributed computing environment utilizing several computer systems and components that are interconnected via communication links, using one or more computer networks or direct connections. However, it can be appreciated that such a system could operate equally well in a system having fewer or a greater number of components than are illustrated in FIG. 7. Thus, the depiction of the environment 700 in FIG. 7 should be taken as being illustrative in nature and not limiting to the scope of the disclosure.

The various implementations can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most implementations utilize at least one network for supporting communications using any of a variety of commercially-available protocols, such as TCP/IP, OSI, FTP, UPnP, NFS, CIFS, etc. The network can be, for example, a local area network, a wide-area network, a virtual private network, the Internet, an intranet, an extranet, a public switched telephone network, an infrared network, a wireless network and any combination thereof.

In implementations utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof.

Implementations within the scope of the present disclosure can be partially or entirely, realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, EEG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, 13, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 82, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method for entering an ambient assist mode for a digital assistant, the method comprising:
determining, using a set of signals, to activate an ambient assist mode for a client computing device, the client computing device including a screen and a keyboard, the client computing device currently executing in a mode other than the ambient assist mode; and
activating, at the client computing device, the ambient assist mode, the ambient assist mode enabling the client computing device to enter a low power mode and listen for an audio input signal corresponding to a hotword for activating a digital assistant, the digital assistant configured to respond to a command corresponding to the audio input signal using at least the screen of the client computing device.

2. The method of claim 1, wherein the set of signals is based on at least one of recency of a user action, accelerometer data, camera input data, audio input data, time of day, historical user behavior, and user location.

3. The method of claim 1, wherein the client computing device utilizes more power while in the mode other than the ambient assist mode, the client computing device executes one or more applications while in the mode; and the client computing device stops execution of the one or more applications after activating the ambient assist mode.

4. The method of claim 1, further comprising:
receiving audio input data;
determining that the audio input data includes a hotword followed by a voice command;
sending a request including the audio input data to a server to respond to the voice command
receiving a message from the server, the message including information corresponding to an operation to be performed by the client computing device for responding to the voice command; and
performing the operation in response to the received message from the server.

5. The method of claim 4, wherein performing the operation comprises:
providing for display a result of the operation in a full screen display mode on the screen of the client computing device, the result including information associated with the operation.

6. A method for disambiguating a user voice command for multiple devices, the method comprising:
receiving a request including audio input data at a server;
performing, by the server, speech recognition on the audio input data to identify candidate terms that match the audio input data;
determining at least one potential intended action corresponding to the candidate terms, the at least one potential intended action associated with a user command;
determining that a plurality of client computing devices are potential candidate devices for responding to at least one potential intended action;
identifying a particular client computing device among the plurality of client computing devices for responding to at least one potential intended action; and
providing information for display on the particular client computing device, the information corresponding to an action for responding to the user command.

7. The method of claim 6, wherein the request is associated with a user account.

8. The method of claim 7, wherein the plurality of client computing devices are associated with the user account.

9. The method of claim 6, wherein identifying the particular client computing device among the plurality of client computing devices is based on at least one of a volume of the received audio input data, a confidence score associated with the at least one potential intended action associated with the user command, a location of a client computing device, and hardware or software capabilities of a client computing device.

10. The method of claim 6, wherein providing information for display on the particular client computing device, the information corresponding to an action for responding to the user command further comprises:
sending a message to the particular client computing device, the message including the information corresponding to the action for responding to the user command.

11. A system comprising;
a processor;
a memory device containing instructions, which when executed by the processor cause the processor to:
determine, using a set of signals, to activate an ambient assist mode for a client computing device, the client computing device including a screen and a keyboard, the client computing device currently executing in a mode other than the ambient assist mode; and
activate, at the client computing device, the ambient assist mode, the ambient assist mode enabling the client computing device to enter a low power mode and listen for an audio input signal corresponding to a hotword for activating a digital assistant, the digital assistant configured to respond to a command corresponding to the audio input signal using at least the screen of the client computing device.

12. The system of claim 11, wherein the set of signals is based on at least one of recency of a user action, accelerometer data, camera input data, audio input data, time of day, historical user behavior, and user location.

13. The system of claim 11, wherein the client computing device utilizes more power while in the mode other than the ambient assist mode, the client computing device executes one or more applications while in the mode, and the client computing device stops execution of the one or more applications after activating the ambient assist mode.

14. The system of claim 11, wherein the memory device contains further instructions, which when executed by the processor further cause the processor to:
receive audio input data;
determine the audio input data includes a hotword followed by a voice command;
send a request including the audio input data to a server to respond to the voice command;
receive a message from the server, the message including information corresponding to an operation to be performed by the client computing device for responding to the voice command; and
perform the operation in response to the received message from the server.

15. The system of claim 14, wherein to perform the operation further comprises:
providing for display a result of the operation in a full screen display mode of a screen of the client computing device, the result including information associated with the operation.

16. A non-transitory computer-readable medium comprising instructions, which when executed by a computing device, cause the computing device to perform operations comprising:
receiving a request including audio input data at a server;
performing, by the server, speech recognition on the audio input data to identify, candidate terms that match the audio input data;
determining at least one potential intended action corresponding to the candidate terms, the at least one potential intended action associated with a user command;
determining that a plurality of client computing devices are potential candidate devices for responding to at least one potential intended action;
identifying a particular client computing device among the plurality of client computing devices for responding to at least one potential intended action; and
providing information for display on the particular client computing device, the information corresponding to an action for responding to the user command.

17. The non-transitory computer-readable medium of claim 16, wherein the request is associated with a user account.

18. The non-transitory computer-readable medium of claim 17, wherein the plurality of client computing devices are associated with the user account.

19. The non-transitory computer-readable medium of claim 18, wherein identifying the particular client computing device among the plurality of client computing devices is based on at least one of a volume of the received audio input data, a confidence score associated with the at least one potential intended action associated with the user command, a location of a client computing device, and hardware or software capabilities of a client computing device.

20. The non-transitory computer-readable medium of claim 19, wherein providing information for display on the particular client computing device, the information corresponding to an action for responding to the user command further comprises:
sending a message to the particular client computing device, the message including the information corresponding to the action for responding to the user command.
